(19) United States
(12) Patent Application Publication
(10) Pub. No.: US 2013/0179951 A1
(43) Pub. Date: Jul. 11, 2013

(54) Methods And Apparatuses For Maintaining Secure Communication Between A Group Of Users In A Social Network

(71) Applicants: Ioannis Broustis, Millburn, NJ (US); Violeta Cakulev, Millburn, NJ (US); Ganapathy Subramanian Sundaram, Hillsborough, NJ (US)

(72) Inventors: Ioannis Broustis, Millburn, NJ (US); Violeta Cakulev, Millburn, NJ (US); Ganapathy Subramanian Sundaram, Hillsborough, NJ (US)

(21) Appl. No.: 13/345,438

(22) Filed: Jan. 6, 2012

(51) Int. Cl. G06F 21/20

(52) U.S. Cl. 726/6

(57) ABSTRACT

Embodiments address various methods and apparatuses that attempt to minimize the time that the security communication between group members may be at risk due to a user joining or leaving. For example, embodiments include methods of minimizing the time for which a joining member receives a secure commonly shared key and other embodiments include methods of minimizing the time that a user leaving the group has access to data shared within the group through updating the secure commonly shared key.

### CROSS-REFERENCE

This application is related to U.S. patent application Ser. No. 13/345,241 filed Jan. 6, 2012, titled Methods and Apparatuses for Secure Information Sharing in Social Networks Using Randomly-Generated Keys, by Ioannis Broustis, Violeta Cakulev, and Ganapathy Sundaram.

### FIELD OF THE INVENTION

Embodiments of the present invention are directed to methods and apparatuses for maintaining secure communication between a group of users in a social network.

### BACKGROUND

This section introduces aspects that may be helpful in facilitating a better understanding of the invention. Accordingly, the statements of this section are to be read in this light and are not to be understood as admissions about what is in the prior art or what is not in the prior art.

During the last few years, social networking has become one of the main ways of communicating between people. Social networking and/or social networks are intended to be interpreted broadly and to be defined as a social structure made up of individuals (or organizations) called for example, “nodes”, which can be tied (e.g., connected) by one or more specific types of interdependencies, such as, friendship, kinship, common interests, financial exchanges, dislikes, likes, relationships of beliefs, knowledge, prestige, etc. Web-based social networking services, for example, Facebook, Twitter, MySpace, Bebo, LinkedIn, Xing, etc., make it possible to connect people who share interests and activities across political, economic, and geographic borders. Social networks (hereinafter including web-based social networks) provide a new way for individuals to communicate digitally.

However, the vast majority of social networking users today feel insecure, knowing that the information that they share over a social network can be misused by social network operators, for example, cloud operators acting as social network hosts. This is especially the case with enterprise users and customers, which can share confidential, high-value enterprise information using social networks that are hosted in the cloud, i.e., beyond the authority of enterprise IT departments.

In addition, there are issues surrounding maintaining the security of the communications of a group of social network users when a user is added to or removed from the group. For example, if a commonly shared derived key is used to encrypt the groups communications, then when a new user is added to the group there is likely to be a lag time before the new user can begin to take part in the communications, as a new commonly shared key will have to be generated. Similarly, when a user leaves a group, the group's communications are at risk until a new key is generated, which can again take time. Often, in environments like digital social networks, the time factor is related to whether and how often a given user is “online” or active in the social network. Therefore, as discussed, methods and apparatuses to quickly generate new shared encryption keys in these types of dynamic social network environments can be important to maintaining communication security.

### SUMMARY

The aspects described above and other aspects of the subject matter described herein are illustrated by way of example and not limited in the accompanying figures in which like reference numerals indicate similar elements.

As identified above, there can be problems with the security of social networking communications. For example, there may be occasions when a new user wishes to join a group of users of a social network or a user wishes to leave a group of a social network. The following embodiments address various methods and apparatuses that attempt to minimize the time that the security communication between group members may be at risk due to a user joining or leaving. For example, embodiments include methods of minimizing the time for which a joining member receives a secure commonly shared key and other embodiments include methods of minimizing the time that a user leaving the group has access to data shared within the group through updating the secure commonly shared key.

Embodiments include methods for maintaining security between a group of users in a social network, comprising identifying a group of users, U₁ . . . Uₘ of the social network, by a social network host, who securely communicate between each other using a currently commonly derived shared key and adding at least one additional user Uₘ₊₁, who can not derive the shared key, to the group of users of the social network, by the social network host. The method can further include, updating at least one published parameter on which the updated commonly derived shared key is to be based, wherein the group of users and the additional user can now securely communicate between each other using an updated commonly derived shared key based on the updated at least one published parameter.

Embodiments can also include where the updating at least one published parameter step is performed as quickly as possible to ensure continued security between the group of users. Other embodiments can include wherein the at least one published parameter is either X₁ or Xₘ corresponding to user U₁ or Uₘ, respectively, and defined as Xᵢ=aᵢ(aᵢ₊₁P−aᵢ₋₁P), where aᵢ is a secret random number and P is a commonly agreed point on an elliptic curve E′.

Other embodiments include identifying a user of the group of users who is online most often and dynamically defining the identified user as user Uₘ of the group of users, prior to the at least updating parameter step. Yet even other embodiments can include generating an updated commonly derived shared key based on the updated at least one published parameter.

In additional embodiment, the updating at least one published parameter is performed by a user agent associated with at least one user of the group of users and the user agent is associated with user U₁ and/or Uₘ.

In other embodiments, the method can further include, sending a temporary key to users U₂ . . . Uₘ₊₁ prior to the updating the at least one published parameter step and/or sending the temporary key to users U₂ . . . Uₘ using the currently commonly derived shared key. In further embodiments, the method can include sending the currently commonly derived shared key to user Uₘ₊₁ prior to the at least updating parameter step.

Other embodiments include, methods of maintaining security between a group of users in a social network, comprising identifying a group of users, U₁ . . . Uₘ of the social network, by a social network host, who securely communicate between each other using a commonly derived shared key, removing a user Uᵢ from the group of users who securely communicate between each other, and updating at least one published parameter on which the updated commonly derived shared key is to be based, wherein the group of users minus the removed user can now securely communicate between each other without the removed user being able to derive the commonly shared key.

Other embodiments include where the updating at least one published parameter step is performed as quickly as possible and the at least one published parameter is either Xᵢ₋₁ or Xᵢ₊₁ corresponding to user Uᵢ₋₁ or Uᵢ₊₁, respectively, and defined as Xᵢ=aᵢ(aᵢ₊₁P−aᵢ₋₁P), where aᵢ is a secret random number and P is a commonly agreed point on an elliptic curve E′.

Additional embodiments can include where the updating the at least one published parameter is performed by a user agent corresponding to at least one user of the group of users and a user agent corresponds to user Uᵢ₋₁ and/or Uᵢ₋₁. Embodiments also include the methods further including, sending a temporary key to users U₂ . . . Uᵢ₋₁ and Uᵢ₊₁ . . . Uₘ prior to the updating the at least one published parameter step.

Other embodiments include methods of maintaining security between a group of users in a social network, comprising, identifying a group of users, U₁ . . . Uₘ of the social network, by a social network host, who securely communicate between each other using a currently commonly derived shared key, adding at least one additional user Uₘ₊₁, who can not derive the shared key, to the group of users of the social network, by the social network host, switching users Uₘ and Uₘ₊₁ upon the expiration of a timer, wherein user Uₘ did not update its Xₘ value by the end of the timer, and updating at least the Xₘ value, now corresponding to the joining user on which an updated commonly derived shared key is to be based, wherein the group of users and the additional new user, except for switched user Uₘ₊₁ can now securely communicate between each other using the updated commonly derived shared key based on the updated Xₘ value. These embodiments also include, where the updating at least one published parameter step is performed as quickly as possible to ensure continued security between the group of users.

Embodiments include apparatus comprising, a memory, and at least one processor coupled to the memory. The processor can be configured to: identify a group of users, U₁ . . . Uₘ of the social network, by a social network host who securely, communicate between each other using a commonly derived shared key; add at least one additional user Uₘ₊₁ who can not derive the shared key to the group of users of the social network, by the social network host; and update at least one published parameter on which the updated commonly derived shared key is to be based, wherein the group of users and the additional user can now securely communicate between each other using an updated commonly derived shared key based on the updated at least one published parameter.

Other embodiments include apparatus comprising, a memory; and at least one processor coupled to the memory. The processor can be configured to: identify a group of users, U₁ . . . Uₘ of the social network, by a social network host who securely, communicate between each other using a commonly derived shared key; remove a user Uᵢ from the group of users who securely communicate between each other; and update at least one published parameter on which the updated commonly derived shared key is to be based, wherein the group of users minus the removed user can now securely communicate between each other without the removed user being able to derive the commonly shared key.

### BRIEF DESCRIPTION OF THE FIGURES

FIG. 1 shows a social network system with a number of users, including a user joining the group and a user leaving the group, according to embodiments;

FIG. 2 is a flow chart illustrating a method for maintaining communication security of a group of social network users where a new user is added, according to embodiments;

FIG. 3 is a flow chart illustrating a method of maintaining communication security of a group of social network users where a current group user is removed, according to embodiments; and

FIG. 4 is a generalized hardware architecture for implementing secure information sharing between users in a social network, according to embodiments.

### DESCRIPTION OF THE EMBODIMENTS

The term “key” as used herein is generally defined as an input to a cryptographic protocol or method, for purposes such as, but not limited to, entity authentication, privacy, message integrity, etc. The term “friend” as used herein is generally defined as a user of a social network that is part of a group of users that have a common attribute and that have agreed to allow access to at least a part of each other's information on the social network. Also, the term online and its converse, offline, are herein generally defined as the presence or lack of presence of a user, or connectivity or non-connectivity of a user to, for example, to the web or to a digital social network.

A social networking service is an online service, platform, or site that focuses on building and reflecting of social networks or social relations among people, who, for example, share interests and/or activities. A social network service essentially consists of a representation of each user (often a profile), his/her social links, and a variety of additional services. Most social network services are web based and provide means for users to interact over the Internet, such as e-mail, file-sharing and instant messaging. While the vast majority of social networks are open to the public, allowing practically anyone to create an account and start socializing through the network infrastructure, social networking has merely been one of the de-facto tools for intra-enterprise communications, allowing e.g. employees within an enterprise to communicate and exchange ideas and views.

Typically social network applications are hosted by web hosting services which specifically host the user creation of web-based social networking services, alongside related applications. Such services are also known as vertical social networks due to the creation of services that in many cases cater to specific user interests. Due to the large number of users that typically associate with popular social networks, hosting services most commonly reside in the cloud, i.e., in scalable and powerful data centers. Such data centers in many cases are operated under the authority of entities that are not known to the end-user and as a consequence, there may be no inherent trust between the end-user and the social network operator (SNO) or host. This is especially the case with enterprise social networks, where employees exchange enterprise confidential information through the social network, such that the exchanged information is visible to the social network operator. Hence, given that communication among users via social network infrastructures involves sharing of private and/or confidential information, it is apparent that users are not secured against non-trusted social network hosts.

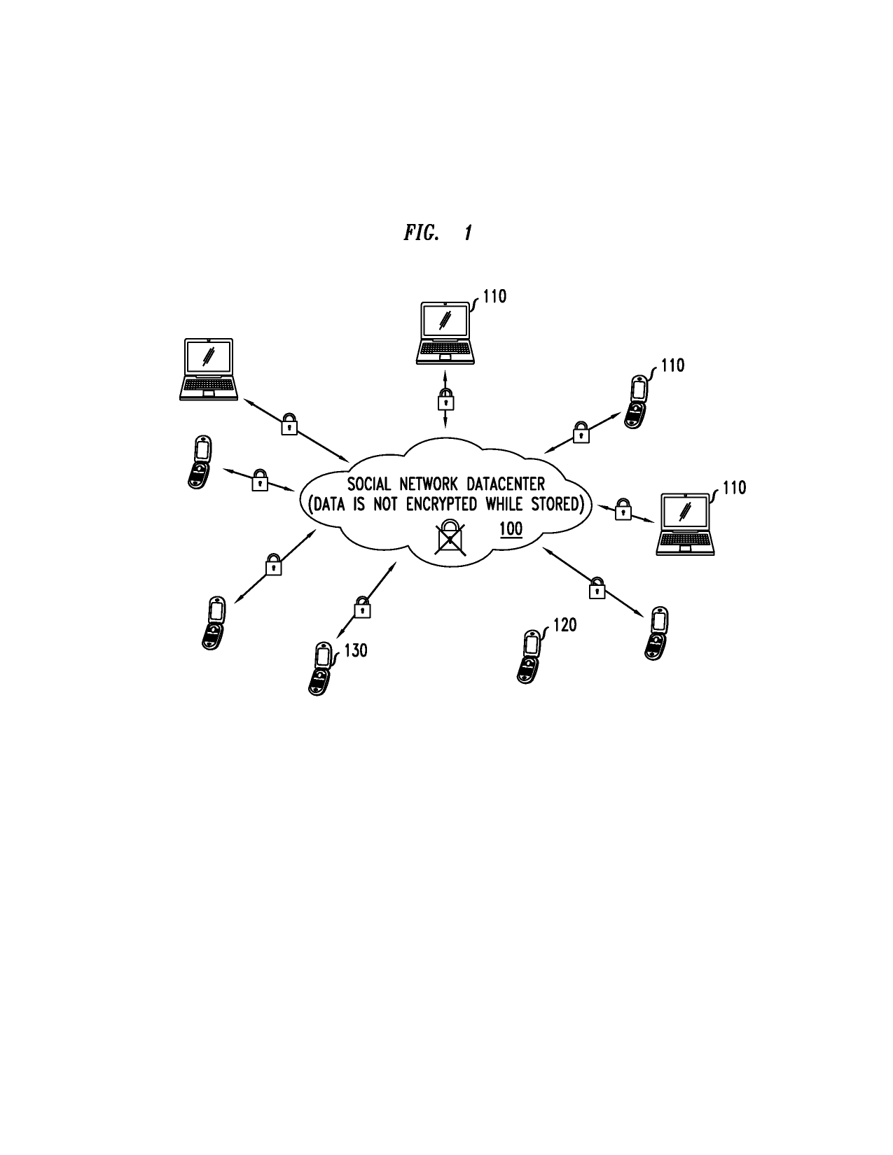

In FIG. 1, it is shown that the social network host/operator 100 typically provides secure interfaces with the end user 110 and with this, user information and data is adequately secured on the communication link with the operator. However, such data is not encrypted while residing within the social infrastructure 100, since it is decrypted as soon as it reaches the operator 100; as a consequence the social network operator 100 can still obtain the data. This poses a significant threat to social networking users 110, especially for the case of enterprise environments; confidential enterprise data may be easily confiscated while stored within the operator's 100 infrastructure. This can result in unprecedented financial costs to enterprises and can further tremendously affect the economics of the Internet.

Note also that most popular social networks may provide some level of protection of user data against unauthorized access from certain users. More specifically, networks provide some means of user authorization with which, a user X is allowed to access user Y's data only if the latter has provided authorization to do so. For example, one of the most popular authorization frameworks that is used in this context is OAuth (Open Authorization). See, for example, E. H. Lahav, Ed, D. Recordon, D. Hardt. The OAuth 2.0 Protocol. draft-ietf-oauth-v2-07, http://tools.ietf.org/html/draft-oetf-oauth-v2-07; and E. H. Lahav, Ed. The OAuth 1.0 Protocol. 1ETF RFC 5849, http://tools.ietf.org/html/rfc5849; both of which are herein incorporated by reference in their entireties. Other examples of authorization frameworks can include Authentication, Authorization, and Accounting (AAA) protocols and Lightweight Development Access Protocol (LDAP), and are not intended to be limited.

OAuth provides a method for clients to access server resources on behalf of a resource owner (such as a different client or an end-user). More generally, it provides a process for resource owners to authorize third-party access to their server resources without sharing their credentials (typically, a username/password pair), using user-agent redirections.

For example, a user has a message to share and sends the message to the social network. The user then identifies other social network users, e.g., A and B, who are friends of the user and who the user wants to share the message with. In order for A and B to obtain the message without using the user's credentials (e.g., username and password), A and B instead each obtain an access token from the user (this process is well known by those of ordinary skill in the art and as documented in the above cited documents) that grants access to A and B to the message. In this scenario, the user is the resource owner and A and B are the third parties. To obtain the message, A and B each supply their access token to the social network and upon validation of the access token, the social network will supply A and B with the message.

However, OAuth still allows the social network operator to access and obtain the end-user's data, since OAuth does not provide any means of end-to-end encryption of data among users; it only provides a means of authorizing whether a specific user is allowed to access another user's data. OAuth does not protect the user's data from unauthorized access by the social network operator, since it inherently assumes that the latter is trusted by the user.

Also shown in FIG. 1 is an example of a user 120 wishing to join the social network 100 and a different user 130 wishing to leave the social network 100. As discussed above, either of these scenarios can also cause security issues for the group of users (e.g., or friends) that the user 120 wishes to join or that the user 130 wishes to leave. In both cases, the time between the user 120 joining or the user 130 leaving, and a new common key being generated for the remaining users in the group so that continued secure communications can continue needs to be minimized. Alternatively, methods for allowing the new user 120 to gain access to group communications and/or methods for preventing the leaving user 130 access to any further group communications can be used, before the updated key is generated.

As discussed above, consider a social network consisting of N users U_{N}=(U₁, U₂, . . . , U_{N}). The network is operated by a Social Network Operator (SNO), which provides OAuth services. Each user Uᵢ wishes to share information only with friends, where a friend is considered to be any user UjεU_{N} that is affiliated with Uᵢ and is authorized to receive Uᵢ's information through OAuth.

Information is typically shared by utilizing a Resource-based Service infrastructure, RS, which can be potentially owned by SNO and which: (a) can provide storage and information dissemination/availability functions, (b) can execute OAuth (Open Authorization) protocol functions (or other authentication and authorization functions), through which users are authorized to access information owned by other (friend) users, and (c) in some cases the SNO can optionally play the role of and/or collaborate with a 3^{rd} party Key Generation Function (KGF), which generate public key related security credentials (e.g. IBE private keys) for each of the N users, as well as for groups of such users.

A user may be online or offline at any instance of time; in other words, not all users are necessarily online at the same time. Given this set-up, a problem that can be addressed is: “How can the information shared through OAuth by user a with friend users, be secured?” In other words, how can Uᵢ make sure that the shared information is stored securely, obtained only by an authorized set of (friend) users, and (if needed) how can those friends verify that the received information is indeed provided by Uᵢ? This has been addressed in co-pending application, U.S. patent application Ser. No. 13/345,241, titled Methods and Apparatuses for Secure Information Sharing in Social Networks Using Randomly-Generated Keys by the same named inventors and which is herein incorporated by reference in its entirety.

Throughout the rest of this discussion there are two main scenarios considered. In the first scenario, a user Uₘ₊₁ wants to join a group of users and in the second scenario, a user Uᵢ wants leave a group of users. In an embodiment, it is assumed that user U₁ wants to share D₁ with users U₂, U₃, . . . , Uₘ, such that information is shared among m≦N users. All N users are assumed to have a pair of keys (a private and a public key), which correspond to a specific user identity (e.g., IBE security credentials). User Uᵢ's private key K_{PRi} is kept secret by Uᵢ, while the corresponding public key K_{PUBi} is known or made available to all N users. It is also assumed that for storage of information shared by Uᵢ, SNO allocates resource storage/container rᵢ. Depending on the social network implementation, rᵢ may be a single resource or multiple mirrored resources, each owned by a different user. Although user authorization operations for accessing resources are handled by OAuth, it is assumed that users may not always trust SNO with regards to how safely the shared information is stored in RS. Therefore one problem addressed is how a user Uᵢ securely stores and later shares the stored information with his friends. All solutions assume the stored information is encrypted and that it can be obtained and decrypted by an authorized set of (friend) users and possibly SNO itself.

In what follows embodiments for the case where IBE private and public keys are used within the context of Identity Based Authenticated Key Exchange (IBAKE) are provided. See, for example, V. Cakulev and G. Sundaram. MIKEY-IBAKE: Identity-Based Authenticated Key Exchange (IBAKE) Mode of Key Distribution in Multimedia Internet KEYing (MIKEY). IETF Network Working Group RFC 6267, June 2011, which is herein incorporated by reference in its entirety.

Other public key methods, such as RSA along with certificates may alternatively be employed. See, for example, C. Adams and S. Lloyd. Understanding PKI: Concepts, Standards, and Deployment Considerations. Addison-Wesley Professional; 2 edition, ISBN-10: 0672323915. 2002, which is herein incorporated by reference in its entirety.

For purposes of notation as used below, E(k, A) denotes that information A is encrypted with the key k, and sμt denotes concatenation of the strings s and t.

According to the present embodiments, in some embodiments a user Uₘ₊₁ wishes to join the group of users U₁ . . . Uₘ. In other embodiments a Uᵢ wishes to leave the group of users U₁ . . . Uₘ. For purposes of these embodiments a commonly shared key can be derived by each user of the “original” (before a user joins or leaves) group of users U₁ . . . Uₘ to be used for secure communication between users/members of the group. One way to derive this common key is using IBAKE. See, for example, V. Cakulev and G. Sundaram. MIKEY-IBAKE: Identity-Based Authenticated Key Exchange (IBAKE) Mode of Key Distribution in Multimedia Internet KEYing (MIKEY). IETF Network Working Group RFC 6267, June 2011, which is herein incorporated by reference in its entirety.

For example, users can engage in a common/shared key derivation process, without having to be constantly online. In these embodiments, each user has been provisioned with an IBE private/public key pair and is able to perform ECC (Elliptic Curve Cryptography) operations. More specifically, with this technique each user Uᵢ generates a random number a, which is kept secret, i.e., it is known only to Uᵢ. Furthermore, Uᵢ publishes the following information:

The value of Zᵢ=aᵢP, where P is a commonly agreed point on an elliptic curve E′. Note that P, E′, as well as other public parameters are freely available.

The value of Xᵢ=aᵢ(aᵢ₊₁P−aᵢ₋₁P) [2].

Moreover, U₁ encrypts D₁ using key K₁; this key is derived as per the following formula:

K₁=Ma₁(Zₘ)+(M−1)X₁+(M−2)X₂+ . . . +Xₘ₋₁. (1)

By encrypting D₁, U₁ creates ciphertext C_{D1} and stores it into r₁. Users U₂, . . . , Uₘ can decrypt C_{D1} by using a key that is calculated locally by each of them. Specifically, each user Uᵢ from the m−1 users calculates the same key Kᵢ as follows:

Kᵢ=Maᵢ(Zᵢ₋₁)+(M−1)Xᵢ+(M−2)Xᵢ₊₁+ . . . +Xᵢ₋₂. (2)

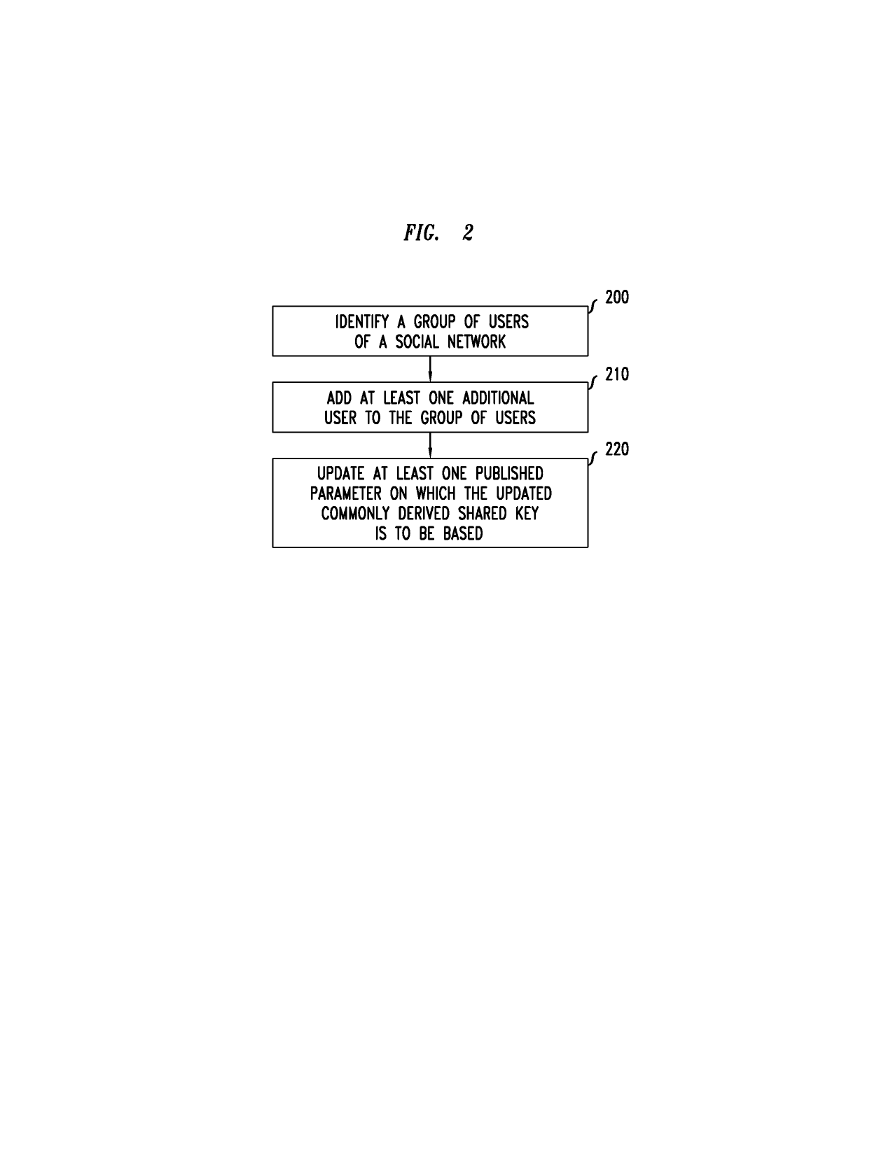

The embodiment shown in FIG. 2, shows that once a group of users is identified at step 200, a new user, Uₘ₊₁ wishes to join the group of users at step 210 among which information D₁ is shared. In view of this new added user, a new common key will need to be derived by all m+1 users in order for the new user to be able to also obtain and de-encrypt D₁. However, before a new common shared key can be derived, U₁ and Uₘ need to update their corresponding Xᵢ's in step 230.

In order for a new group key to be derived by all users, U₁ and U_{M} need to go online and publish their Xᵢ values first. In either cases, the user may not be online or may remain offline for an “unreasonable” period of time. As used herein “reasonable” and “unreasonable” periods of time would depend on the group of users habits and norms. For example, an unreasonable amount of time for a group of users that are working on a critical project that is time sensitive could be a few seconds, while conversely, a group of users who occasionally share recipes, a reasonable period of time might be a few days. Regardless, it is assumed that in most scenarios, the group of users will prefer to minimize the amount of time that a user joining is unable to securely communicate with the rest of the group; as well as the time that a user leaving can continue to securely communicate with the group.

For purposes of this embodiment, it is assumed that U₁ has published its updated X₁ and authorized user Uₘ₊₁ to join the group in a reasonable time period. However, user Uₘ has stayed offline and therefore Xₘ has not been updated in a reasonable period of time. During this time “lag,” a new group key cannot be generated and therefore, user Uₘ₊₁ cannot access the shared information D₁. It is noted that other embodiments are possible and intended to be included within the scope of this application as suggested above.

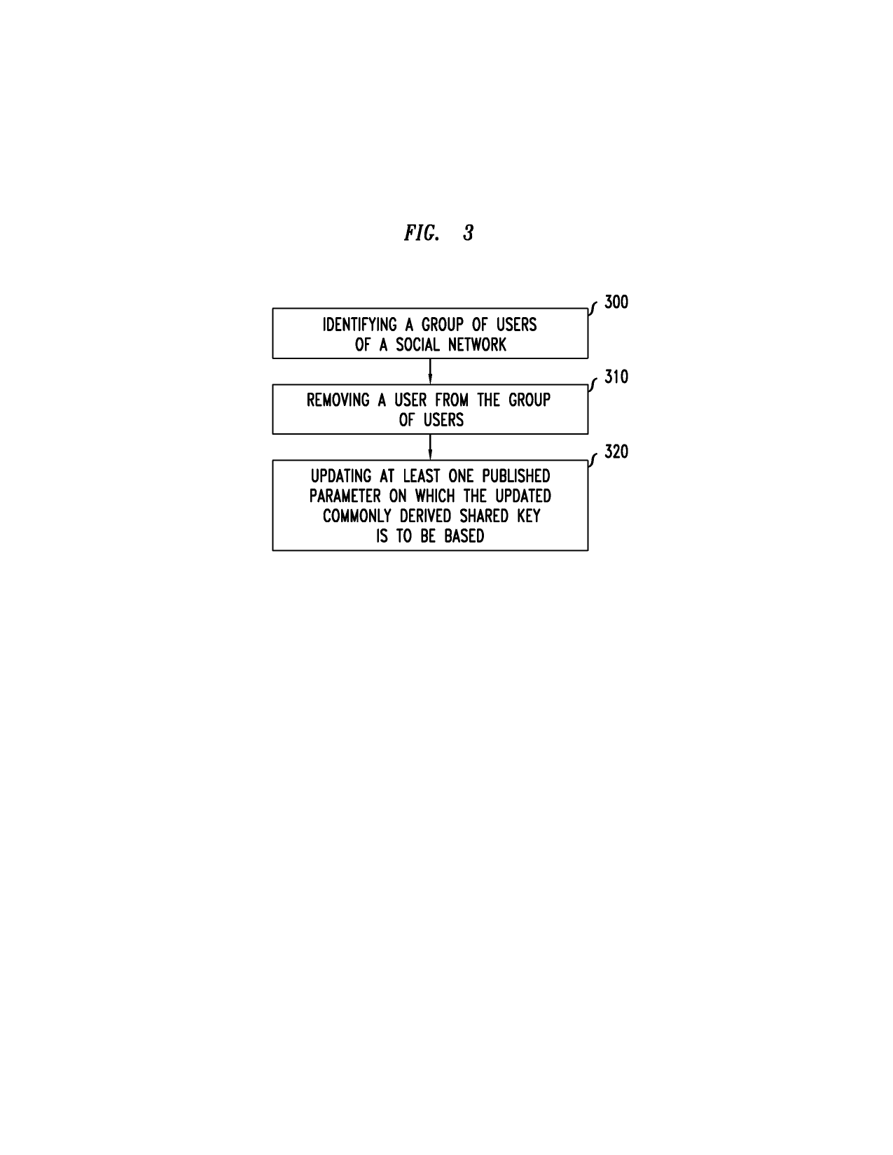

Opposite to FIG. 2, FIG. 3 shows an embodiment where a user of the group of users leaves the group. As shown in step 300, a group of users is identified and then user Uᵢ indicates that he wishes to leave the group in step 310. Based on user Uᵢ leaving, parameters related to the shared commonly derived key are updated in step 320. In contrast to the embodiments where user Uₘ₊₁ is added and where the parameters of users U₁ and Uₘ are updated, in the embodiment shown in FIG. 3, the parameters of users Uᵢ₋₁ and Uᵢ₊₁ can be updated. For example, users Uᵢ₋₁ and Uᵢ₊₁ respective X values can be recalculated and published in order for the remaining users of the group to be able to generate the new commonly shared key. Until the derivation of the new key and the re-encryption of D₁, user Uᵢ still has access to the shared information, even though the group does not include Uᵢ anymore.

In order to reduce the time during which Uₘ₊₁ has no access to D₁ and/or Uᵢ does have access to D₁ several optimization methods are possible. These optimization methods are described below.

Employing user agents: User agents are helpful when to create a security association all the participants are required to, but can not be online at the same time. A user agent is an entity that is always online on behalf of the associated user for the purposes of setting up security associations, as well as for dissemination and retrieval of a users' updated information related to social networking. More specifically, such a security association process would require all users U₁, U₂ . . . , Uₘ to be online at the same time in order to exchange security related information. Clearly in the case of social networking with users being humans, such a scheme would be impractical, since it would enforce all friends to be simultaneously online for a certain amount of time, in order to set-up common shared secrets. On the other hand, employing user agents (typically realized as application layer objects or potentially even as virtual machines) that remain constantly online in order to establish security associations on behalf of their affiliated users, renders such security association schemes quite practical.

Given this, each user U can have at least one affiliated user agent, A_{U}, which remains constantly online and resides somewhere in the network (potentially in the premises of the SNO, or in a local trusted server near the user, etc). Typically a new user agent is constructed upon initial registration of the user with the SNO; there may be cases where the user agent is in fact the entity that signs-up for a new user account as well as the entity that (re)registers with an SNO on behalf of the user (potentially in automated communications environments). In other cases, a trusted user agent may be operating on behalf of more than one user, and be able to securely differentiate information related to each user by securely communicating with a trusted local database as well as separately with each user. In a more distributed setting, deploying user agent hierarchies is also a potential approach. With user agent hierarchies, distributed sets of user agents may be locally communicating with a “super-user agent”, which serves the purpose of a “cloudlet-SNO”, i.e., a condensed form of the main SNO, affiliated with an RS that stores information exclusively for the underlying associated agents.

Nevertheless, even when complex ecosystems of user agents are architected, this solution can be applicable as long as the participating agents are simultaneously online for the purposes of setting up security associations (both/either local and/or global).

As applied to the above embodiments, if the users U₁ . . . Uₘ are always online as associated/represented by a user agent, then the time period lag described above with the addition or withdrawal of a user to the group of users is minimized. For example, as long as user U₁, Uᵢ₋₁, Uᵢ₊₁, and Uₘ have associated user agents, then the updating of their respective X parameters would be approximately immediate.

Different approaches for security association establishment among a set of user agents can be adopted. See, for example, V. Cakulev, G. Sundaram. MIKEY-IBAKE: Identity-Based Authenticated Key Exchange (IBAKE) Mode of Key Distribution in Multimedia Internet KEYing (MIKEY). IETF RFC 6267, http://tools.ietf.org/html/rfc6267, and T. Dierks, E. Rescorla. The Transport Layer Security (TLS) Protocol Version 1.2. IETF RFC 5246, http://tools.ietf.org/html/rfc5246, both of which are herein incorporated by reference in their entireties. In fact, all of the solutions discussed below can be applicable with user agents as well. Note that various approaches for the establishment of security associations between users and user agents are possible.

Use of temporary Keys: Upon authorizing user Uₘ₊₁ to join the group, or after user Uᵢ leaves the group, user U₁ can issue a temporary key to be used until appropriate X values are updated/published, and a new group key is generated that can be used for accessing new data.

In embodiments where a new user is joining the group of users, the temporary key can be sent to users U₂ to Uₘ and can be encrypted with the old group key in embodiments. Hence, in cases of a user joining the group, this user can have almost immediate access to the shared information D₁.

Similarly, in embodiments where a user is leaving the group of users, the temporary key can be sent to users U₂ . . . Uᵢ₋₁, Uᵢ₊₁ . . . Uₘ. In these embodiments, the leaving user's access to the shared information diminishes almost immediately.

In all the embodiments, once all updated X values are published, user U₁ protects the shared information D₁ with the newly generated common key and informs all users to start using this new common key generated by all participants in the group.

Revealing key-in-use: Upon authorizing user Uₘ₊₁ to join the group, user U₁ can securely provide the current key-in-use to user Uₘ₊₁. Therefore, in embodiments of a user joining the group, this user has immediate access to the shared information D₁, as well as to all the previous shared information. Although note that this approach does not affect the embodiments of a user leaving the group as a user leaving the group will still have access to the shared information until a new key is generated.

In order to limit the amount of “old” information that the new user has access to, (assuming that users U₁ to Uₘ do not wish to make data older than D₁ available to Uₘ₊₁), old data may be encrypted with different keys, which are known only to intended group users. Hence, assuming that U₁ allows all U₂-Uₘ users to have access to all data (even older than D₁—denoted as D₁₋), a different key can be used to encrypt D₁₋; such a key can be mutually agreed among users U₁, U₂, . . . , Uₘ, prior to the arrival of Uₘ₊₁. Also note that if this approach is followed (with the intent that new users cannot have access to old data), different subgroups within the group of m users will be maintaining more than one key, with which they are able to access data that was generated within a certain time interval.

User reordering: Upon authorizing user Uₘ₊₁ to join the group, a timer can be set allowing a certain amount of time before user Uₘ is expected to publish its updated Xₘ. Once this timer expires and if user Uₘ has not published its updated Xₘ, user the group of users can be reordered such that user Uₘ becomes Uₘ₊₁ and Uₘ₊₁ becomes Uₘ.

In these embodiments, the reordering allows the new user following reordering to update its X value and at least allow the reordered group of users to generate a new commonly shared key, which original user Uₘ can not generate or participate in until user Uₘ updates its X value. However, it is noted that even after reordering the users, the user that is joining the group (i.e., user Uₘ after reordering) still has no access to the previously shared information since now user Uₘ₋₁ needs to update its Xₘ₋₁.

As to the embodiments related to a user leaving the group, this method does not affect (i.e. does not reduce) the time during which a user that left the group has access to the shared information. Therefore, a user Uⱼ that left the group has access to D₁ until users Uᵢ₋₁ and Uᵢ₊₁ update their Xᵢ₋₁ and Xᵢ₊₁ respectively so that a new group key can be generated.

Most “online” user: User U₁ through the Social Network can keep track of users that are most online and select the user that is online the most as the “last” user (i.e. user Uₘ). Observe that in these embodiments using user agents, U₁ can obtain the information about most online user from its A_{U}. In this case once a new user Uₘ₊₁ joins the group there is higher probability that user Uₘ will publish its updated Xₘ in a reasonable amount of time, therefore there is higher probability that user Uₘ₊₁ will have access to the shared information in a reasonable amount of time.

In a very dynamic social network, user U₁ needs to keep reordering the users in order to have the user that is most online as the ‘last’ user. Constant reordering can be limited by using a popularity threshold metric. Such a metric could be related to the time interval between two consecutive user visits to its account, or the number of friends of a user compared to other users, etc. For example, a reordering may be performed if the currently most popular user in the group (Uₘ) does not sign in for k minutes after the last visit to its social account, of if the relative frequency of visiting the account is smaller by a threshold to the average frequency of the users in the group, etc.

Also, in these embodiments where a user is leaving the group, this approach does not affect (i.e. does not reduce) the time during which a user that left the group has access to the shared information.

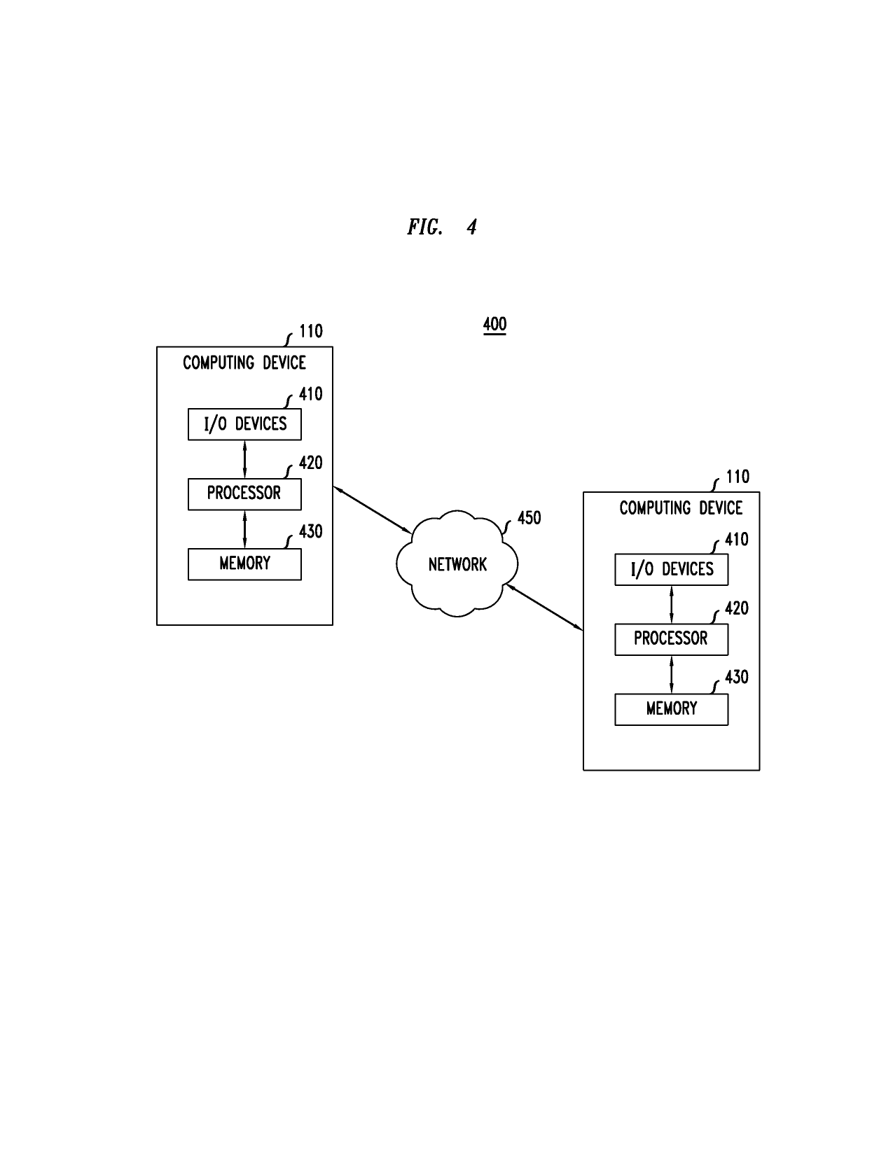

Finally, FIG. 4 illustrates a generalized hardware architecture 400 of a network environment and communication devices in the form of computing devices suitable for implementing a secure key management protocol between at least two entities according to the present invention. While FIG. 4 shows only two entities, it is to be understood that other entities can have the same configuration. Thus, in terms of the secure key management protocols described above, the two entities may be users 110. However, KGFs, functional elements, additional users (parties) and additional servers may be implemented with the same architecture as shown in a computing device of FIG. 4. Thus, for the sake of simplicity, all the computing devices (communication devices) that may participate in the protocols of the invention are not shown in FIG. 4.

As shown, computing devices designated 110 are coupled via a network 450. The network 450 may be any network across which the devices are able to communicate, for example, as in the embodiments described above, the network 450 could include a publicly-accessible wide area communication network such as a cellular communication network operated by a network operator (e.g., Verizon, AT&T, Sprint). However, the invention is not limited to a particular type of network. Typically, the devices could be client machines. Examples of client devices that may be employed by the parties to participate in the protocols described herein may include, but are not limited to, cellular phones, smart phones, desktop phones, personal digital assistants, laptop computers, personal computers, etc. However, one or more of the devices could be servers. Thus, it is to be understood that the communication protocol of the present invention is not limited to the case where the computing systems are client and server, respectively, but instead is applicable to any computing devices comprising the two network elements.

As would be readily apparent to one of ordinary skill in the art, the servers and clients may be implemented as programmed computers operating under control of computer program code. The computer program code would be stored in a computer readable storage medium (e.g., a memory) and the code would be executed by a processor of the computer. Given this disclosure of the invention, one skilled in the art could readily produce appropriate computer program code in order to implement the protocols described herein.

Nonetheless, FIG. 4 generally illustrates an exemplary architecture for each computer system communicating over the network. As shown, devices 110 comprises I/O devices 410, processors 420, and memories 430. It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM). In addition, the term “I/O devices” as used herein is intended to include one or more input devices (e.g., keyboard, mouse) for inputting data to the processing unit, as well as one or more output devices (e.g., CRT display) for providing results associated with the processing unit.

Accordingly, software instructions or code for performing the methodologies of the invention, described herein, may be stored in one or more of the associated memory devices, e.g., ROM, fixed or removable memory, and, when ready to be utilized, loaded into RAM and executed by the CPU.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

While the teachings have been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. As used herein, the term “and/or” with respect to a listing of items such as, for example, A and/or B, means A alone, B alone, or A and B. Those skilled in the art will recognize that these and other variations are possible within the spirit and scope as defined in the following claims and their equivalents.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method of maintaining security between a group of users in a social network, comprising:
identifying, by a social network host, a group of users, U₁ . . . Uₘ of the social network who securely communicate between each other using an initial commonly derived shared key that the social network host can not derive;
adding, by the social network host, at least one additional user Uₘ₋₁ to the group of users of the social network, wherein the at least one additional user cannot derive the initial shared key; and
storing shared data D₁ sent by one user in said group of users, the shared data being encrypted by an updated commonly derived shared key.

2. The method of claim 1, wherein the updated commonly derived shared key is derived by the group of users in response to adding the at least one additional user.

3-5. (canceled)

6. The method of claim 1, wherein the updating of the at least one published parameter is performed by a user agent associated with at least one user of the group of users.

7. The method of claim 6, wherein the user agent is associated with user U₁ and/or Uₘ.

8. The method of claim 1, further comprising:
sending a temporary key to users U₂ . . . Uₘ₊₁ prior to the updating the at least one published parameter step.

9. The method of claim 8, further comprising:
sending the temporary key to users U₂ . . . Uₘ using the initial commonly derived shared key.

10. The method of claim 1, further comprising:
sending the initial commonly derived shared key to user Uₘ₊₁ prior to the at least updating parameter step.

11. A method of maintaining security between a group of users in a social network, comprising:
identifying a group of users, U₁ . . . Uₘ of the social network, by a social network host, who securely communicate between each other using a commonly derived shared key that the social network host can not derive;
removing a user Uᵢ from the group of users who securely communicate between each other; and
updating at least one published parameter on which the updated commonly derived shared key is to be based, wherein the group of users minus the removed user can now securely communicate between each other without the removed user being able to derive the commonly shared key without the social network host being able to derive the commonly shared key.

12. (canceled)

13. The method of claim 11, wherein the at least one published parameter is either Xᵢ₋₁ or Xᵢ₊₁ corresponding to user Uᵢ₋₁ or Uᵢ₊₁, respectively, and defined as Xᵢ=aᵢ(aᵢ₊₁P−aᵢ₋₁P), where aᵢ is a secret random number and P is a commonly agreed point on an elliptic curve E′.

14. The method of claim 11, wherein the updating the at least one published parameter is performed by a user agent corresponding to at least one user of the group of users.

15. The method of claim 14, wherein a user agent corresponds to user Uᵢ₊₁ and/or Uᵢ₋₁.

16. The method of claim 11, further comprising:
sending a temporary key to users U₂ . . . Uᵢ₋₁ and Uᵢ₊₁ . . . Uₘ prior to the updating the at least one published parameter step.

17. A method of maintaining security between a group of users in a social network, comprising:
identifying a group of users, U₁ . . . Uₘ of the social network, by a social network host, who securely communicate between each other using a initial commonly derived shared key that the social network host can not derive;
adding at least one additional user Uₘ₊₁, who can not derive the shared key, to the group of users of the social network, by the social network host;
switching users Uₘ and Uₘ₊₁ upon the expiration of a timer, wherein user Uₘ did not update its Xₘ value by the end of the timer; and
updating at least the Xₘ value, now corresponding to the joining user on which an updated commonly derived shared key is to be based, wherein the group of users and the additional new user, except for switched user Uₘ₊₁, can now securely communicate between each other using the updated commonly derived shared key based on the updated Xₘ value, without the social network host being able to derive the updated commonly shared key.

18. (canceled)

19. An apparatus comprising:
a memory; and
at least one processor coupled to the memory and configured to:
identify a group of users, U₁ . . . Uₘ of the social network, by a social network host who securely, communicate between each other using an initial commonly derived shared key that the social network host can not derive;
add at least one additional user Uₘ₊₁ who can not derive the shared key to the group of users of the social network, by the social network host; and
update at least one published parameter on which an updated commonly derived shared key is to be based, wherein the group of users and the additional user can now securely communicate between each other using the updated commonly derived shared key based on the updated at least one published parameter without the social network host being able to derive the updated commonly shared key.

20. An apparatus comprising:
a memory; and
at least one processor coupled to the memory and configured to:
identify a group of users, U₁ . . . Uₘ of the social network, by a social network host who securely, communicate between each other using a commonly derived shared key that the social network host can not derive;
remove a user Uᵢ from the group of users who securely communicate between each other; and
update at least one published parameter on which an updated commonly derived shared key is to be based, wherein the group of users minus the removed user can now securely communicate between each other without the removed user being able to derive the updated commonly shared key and without the social network host being able to derive the updated commonly shared key.

21. A method of maintaining security between a first user and additional users in a social network, comprising:
securely communicating between members of a first group of users that includes the first user and a first number of the additional users using an initial commonly shared key derived by the first user from parameters provided by the first number of additional users;
deriving an updated commonly derived shared key by the first user from parameters provided by a second different number of additional users; and
securely communicating between members of a second group of users that includes the first user and the second number of additional users.

22. The method of claim 21, further comprising the first user publishing at least one parameter from which the first user and the additional users derive the updated common derived shared key.

23. The method of claim 22, wherein the at least one published parameter is either X₁ or Xₘ corresponding to user U₁ or Uₘ, respectively, and defined as Xᵢ=aᵢ(aᵢ₊₁P−aᵢ₋₁P), where aᵢ is a secret random number and P is a commonly agreed point on an elliptic curve E′.

24. The method of claim 22, further comprising:
identifying a user of the first group of users who is online most often; and
dynamically defining the identified user as user Uₘ of the first group of users, prior to the publishing step.

25. The method of claim 21, wherein the second group includes the members of the first group and a new user.
